(19) United States
(12) Patent Application Publication
(10) Pub. No.: US 2025/0289041 A1
(43) Pub. Date: Sep. 18, 2025

(54) METHOD AND PLANT FOR TREATING WASTE MATERIALS

(71) Applicant: Johannes Wissing, Stadtlohn (DE)

(72) Inventor: Johannes Wissing, Stadtlohn (DE)

(21) Appl. No.: 18/850,682

(22) PCT Filed: Mar. 23, 2023
(86) PCT No.: PCT/EP2023/057568

§ 371 Date: May 22, 2025

(30) Foreign Application Priority Data
Mar. 25, 2022 (DE) 102022107082.4

(51) Int. Cl. B09B 3/50; B09B 3/30; B09B 3/70

(52) U.S. Cl. CPC B09B 3/50; B09B 3/30; B09B 3/70

(57) ABSTRACT

The invention relates to a plant for treating comminuted waste materials, comprising: a reactor, which has a treatment chamber, for receiving a waste suspension containing the waste materials and a treatment fluid; at least one ultrasound generator; and a control unit by means of which the ultrasound generator can be adjusted and serves to adjust a treatment intensity. According to the invention, a detection unit is provided which serves to determine an amount of material in the waste suspension. The invention also relates to a method for treating comminuted waste materials, wherein the waste materials are present as a waste suspension in a treatment fluid, and wherein the waste suspension is subjected to ultrasonic treatment (1). According to the invention, at least one amount of material in the waste suspension is detected as an actual value, and a treatment intensity is regulated if the actual value deviates from a target value.

The invention relates to a plant according to the features in the preamble of claim 1 and to a method according to the features in the preamble of claim 12, according to which ultrasound forms the starting point for the provision of processed waste materials.

It is generally sought to recycle waste materials, in order to be able to reduce resource consumption in support of environmental protection. A requirement for this is that the waste materials are processed, specifically in such a way that they are available by type, with high quality, in treated, for example cleaned form.

For reasons of transportability and storage, waste materials are in principle firstly comminuted, for example by means of a shredder. This makes the geometry of the comminuted waste materials highly variable, generally between a few millimeters of edge length through several centimeters, of scraps of film, foil or paper, to fragments.

The meaning of the present proposition takes into account waste materials of various types, from (foodstuff) packaging such as beverage cartons made of paper, plastic and/or aluminum, yoghurt pots and other aluminum-plastics composites through to electronic components such as photovoltaic modules made of glass, semiconductors, plastics, and rechargeable lithium ion batteries made of aluminum, lithium-metal oxide, graphite, copper; and also safety glass, e.g. windshields made of glass, polyvinyl butyral; and so on.

A characteristic of waste materials is high material heterogeneity, and they generally exist in the form of stuck-together substance composites that make them harder to recycle. Added to this are adhesions, among other things of organic nature, which can adversely affect the odor of the waste materials in the long term.

The use of ultrasound to process waste materials is known from the prior art. For this, the waste materials are transferred into a suspension, generally by mixing comminuted waste materials with a treatment liquid, for example water, and exposing them to ultrasound. In the waste suspension, ultrasound has the effect of forming steam bubbles, abruptly which collapse back on themselves. These releases of energy in the manner of pressure and temperature increases within the framework of an ultrasonic treatment are used to recycle, in particular clean waste materials, dissolve paints, break up material and/or substance composites and separate substances from one another by type.

It is known from practice to treat and thus clean waste materials within the framework of a wash with ultrasound, among other things in order to be able to destroy pathogens in sanitizing fashion or neutralize odorous adhesions. DE 30 28 690 A1 discloses an apparatus and a method for cleaning contaminating objects, wherein a mechanical-chemical washing device is combined with an ultrasonic cleaning device. DE 41 26 145 A1 relates to a method and a plant for processing biologically contaminated waste for recycling. What is proposed is a hot wash in combination with an ultrasonic treatment, among other things to improve the quality for reprocessing, it being possible to provide a prior comminution of the plastics.

For dissolving and discharging of printing inks, the use of ultrasound is known from practice. DE 27 09 515 A1 relates to a method and an apparatus for removing coatings on metallic objects. What is proposed is to dissolve paint and/or lacquer layers in an ultrasound field. U.S. Pat. No. 5,413,675 A discloses a method for deinking laserjet-printed paper waste. What is proposed is how to dissolve and discharge a heat-resistant ink on the paper waste with a solvent and by means of ultrasound.

It is known from practice to break up substance-composite systems using ultrasound. DE 103 12 953 A1 relates to a method for separating composite bodies. What is proposed is to sever the connection between a foam and the outer layer lying on the foam by introducing a liquid and performing an ultrasonic treatment. Adding minerals to the liquid enhances the detachment. A method for removing coatings from expandable styrene polymers is disclosed in DE 195 23 588 A1. What is proposed is in particular to remove coatings from polystyrene beads in a liquid bath by means of ultrasound.

It is known that adherent gases can be removed from waste materials in microdispersion by means of ultrasound, with the result that for example the separation by type is simplified. An apparatus and a method for the sink-float separation of solid particles of different densities is known from EP 2 033 713 A1. What is proposed is to use ultrasound generators to remove air elements from the solid particles, in order to thereby be able to achieve better separation.

A pronounced heterogeneity is a known characteristic of waste materials, specifically in terms of the substances and also as regards any adhesions or the like. Presorting is expensive and increases the resource consumption required. The known practice for treating waste materials is generally subject to the problem that a resource-intensive procedure is inevitable in order to be able to reliably achieve processing to the greatest possible extent.

The present invention is based on the object of improving the known treatment practice in order to be able to provide high-quality waste materials for the purpose of efficient value creation. The intention is to minimize the required resource consumption and harmful effects on the environment.

The object is achieved by a plant according to the features of claim 1 and by a method according to the features of claim 12. Advantageous embodiments are explained in more detail in the dependent claims.

The invention proposes in other words to take indicators, which is to say at least one detected amount of substance and/or one value for a detected amount of substance, as a starting point to adapt the intensity of the ultrasonic treatment, with the result that it is possible to convert comminuted waste materials into high-value raw materials and/or reusable materials, on the premise that the resource consumption required for this can be kept to a minimum. Within the framework of a comprehensive processing, as proposed the waste materials can be cleaned, deinked, broken up and/or separated by type.

What is proposed is a plant comprising a reactor, which has a treatment chamber for receiving a waste suspension. The waste suspension, which is composed substantially of comminuted waste materials and a treatment liquid, is exposed to sound in the treatment chamber. Structural features of the reactor thus define both an effective sound-exposure coverage and the extent of the sound-exposure chamber.

For the treatment, at least one ultrasonic generator and/or ultrasonic transducer, for example a rod transducer, is provided. Advantageously, multiple ultrasonic generators may be provided, preferably in an arrangement which promotes a positive superposition of the ultrasound in the reactor, but largely excludes it canceling itself out.

To activate the ultrasonic generator, a control unit is provided. In the simplest case, for this purpose it may generate an output signal, which initiates a (de)activation of the ultrasonic generator. It may furthermore be provided to use the control unit to set a certain frequency range of the emitted ultrasound to define the ultrasonic power, and thereby in principle the treatment intensity.

The plant has as proposed a detection unit, which serves to be able to indicate one or more amounts of substance in the waste suspension as starting point for a possibly necessary adaptation of the treatment intensity. The detected amount of substance can be set in relation to a further amount of substance and/or a volume of substance to quantify a relative variable, for example a concentration of substance.

Advantageously, it may be provided that the detection unit has a filter apparatus, in particular a filter apparatus for removing suspended matter from the liquid phase of the waste suspension. Suspended matter is generally insoluble, organic or mineral solids in the waste suspension, among other things foodstuff residues, adhesive-substance residues, or the like, which pass into the waste suspension with the comminuted waste materials. The amount of suspended matter can be easily approximated, for example by gravimetry, by weighing a filter.

For a further embodiment, it may be provided that the detection unit has an optical and/or a spectroscopic functionality for detecting the suspended matter. For example, it may be provided to determine the amount of suspended matter by photometry. Spectroscopic analysis methods can be advantageous in particular for identifying specific substances, and generally this does not involve a directly quantitative determination of the amount, but instead conclusions for an adaptation of the treatment intensity may be provided only when a particular amount of substance is reached in the sense of a detection limit.

Advantageously, the detection unit is configured to be able to determine the acidic or basic nature of the waste suspension. It is thus possible for example for the pH to provide information as to whether certain reactions are taking place in the waste suspension and/or whether certain auxiliaries which are optionally added to the waste suspension are active.

The detection unit may be configured in such a way that multiple indicators can be determined, and this can make a contribution to higher process reliability.

For a particularly advantageous embodiment, it may be provided that the plant has a regulation system that connects the control unit to the detection unit, such that the detection unit generates an input signal and the control unit, on corresponding prompting the regulation system, generates an output signal for regulating the treatment intensity depending on the one or more detected indicators. In particular an automated regulation system which enables a procedure substantially independent of personnel can advantageously be provided. Moreover, such a regulation system ensures optimized consumption of resources, in that the treatment method is individually adapted to the waste materials to be treated. A centralized regulation system moreover has the advantage of simplifying the procedure, for example by virtue of an overview-like visualization of the process factors with the effective variable settings.

For a further embodiment of the plant, it is possible to provide a temperature-control unit, which is intended to set the temperature of the waste suspension. For example, the plant may have a heating rod, which directly heats the waste suspension. It may likewise be provided to directly control the temperature of the treatment liquid before it is mixed with the waste materials. In the simplest case, the temperature-control unit may be controlled by a control unit without incorporation in and/or without feedback from a regulation system.

In principle, the effectiveness of the treatment method can be increased with increasing temperature of the waste suspension, although this is also associated with increased resource consumption. It is in particular advantageous to incorporate, with signal transmission, the temperature-control unit in the regulation system. This makes it possible to regulate the treatment intensity via setting a specific temperature, specifically on the basis of certain indicators.

Advantageously, the plant has a mixing vessel with a stirring mechanism. In the mixing vessel, the comminuted waste materials are blended with the treatment liquid. A stirring mechanism can contribute to homogenizing the waste suspension, for example by preventing certain waste materials from floating and by distributing the waste materials uniformly in the waste suspension. After the mixing, the waste suspension can be conducted into the treatment chamber of the reactor for treatment.

Firstly, a mixing vessel can act as a buffer store, in order to be able to ensure a substantially continuous treatment in the reactor. Secondly, the mixing vessel may have at least one detection unit, with the result that it is possible to detect the actual state of the waste suspension, in order to be able to implement a subsequent ultrasonic treatment in a reactor in optimized fashion, for example in terms of the intensity of the ultrasonic treatment and/or the temperature of the waste suspension.

For precise addition of comminuted waste materials and/or of a treatment liquid, in particular water, for the production of the waste suspension, the plant may have a metering device with one or more metering elements. Any auxiliaries required, for example caustic soda solution or the like, which can influence the effectiveness of the treatment process, can in particular be feedable via a metering device in a precise quantity ratio, in order to both save on resources and minimize potential effects on the environment.

In particular for a treatment of the waste suspension in stages, it may be provided that the plant has multiple interconnected reactors. The treatment intensities in the reactors can thus be different, for example depending on the distinct form of certain indicators. A detection unit, which is arranged in such a way that amounts of substance in the waste suspension are detected after a first treatment in a first reactor, can provide information about indicators in order to be able to regulate a correspondingly adapted treatment intensity of a second ultrasonic treatment in a second reactor.

For one embodiment of the plant, it may be provided that a conveying apparatus, which brings about a waste-suspension stream, is arranged specifically in particular between the mixing vessel and the reactor and/or between reactors and/or in the treatment chamber of one or more reactors. Advantageously, a positive displacement pump may be provided for this owing to the efficiency.

A conveying apparatus can be used to be able to implement circulating operation for a treatment process in the proposed plant. For example, it may be provided to feed the waste suspension back to a reactor, for example if at least one detected indicator indicates that an additional treatment is necessary. Such circulating operation can in principle be regarded as equivalent to a lengthening of the treatment duration and constitutes the simplest form of regulating the treatment intensity.

In particular advantageous is exposing the waste suspension to sound on the counterflow principle. For a further embodiment of the plant, it may therefore be provided that the reactor has an impact wall, which is aligned substantially orthogonally to the alignment of the waste-suspension stream and is arranged in the waste-suspension stream. At least one ultrasonic generator, which is arranged such that ultrasound can be introduced into the waste suspension via the impact wall substantially counter to the flow direction of the waste-suspension stream, can be assigned to the impact wall. In the course of this, the treatment intensity can be constructively increased, without an increased resource consumption, in particular an increased energy consumption, being necessary for this.

In particular in support of a treatment process in a continuous mode of operation, it may preferably be provided that the reactor is substantially tubular, and that the waste suspension flows through the treatment chamber of the reactor during the treatment. A tubular reactor is advantageous in order to be able to realize for example a precise flow velocity of the waste suspension, for example in conjunction with a conveying apparatus and the ratio of cross-sectional dimensions of the reactor and delivery volumes of the waste-suspension stream.

Compared to a vessel-based ultrasonic treatment, generally in a batch method, the exposure to sound of a waste suspension in a tubular reactor through which flow can pass can be much more effective, for example owing to an increased likelihood of a fully comprehensive exposure of the waste materials to sound. Firstly, the waste materials in the waste-suspension stream can be carried past one or more ultrasound sources with a very small spacing. Secondly, a delivery of the waste materials in the treatment chamber can bring about permanent through-mixing and thus an associated homogeneous exposure to sound. It is thus possible to omit stirring mechanisms, which generally favor the production of microplastics, in particular in the case of waste materials with brittle strength properties, for example in the case of plastics such as polyethylene terephthalate.

Also proposed is a method for ultrasonic treatment of a waste suspension, which contains comminuted waste materials and a treatment liquid. In principle, a batchwise procedure may be provided, but it is preferably a continuous one.

According to the invention, it is provided that, in the waste suspension, at least one amount of substance is detected based on an indicator. This input signal detected as actual value is the starting point for regulation of the treatment intensity. In particular in the event of a deviation of the actual value from a predefined setpoint value outside a tolerance range, which is to say that the processing of the treated waste materials is insufficient, for example in terms of the degree of cleaning or break-up, a regulation system can generate an output signal, preferably in automated fashion, which has the effect of adapting the treatment intensity via a control unit. The tolerance range within which an ascertained deviation does not present a problem can be aligned with the type of waste materials or the like on a case-by-case basis.

Optimum regulation of the treatment intensity is for example advantageous in order to avoid unnecessarily impairing essential features of the waste materials, for example strength properties, as a result of the ultrasonic treatment.

For an advantageous embodiment of the method, it may be provided that an actual value is detected before a treatment of the waste suspension in the process sequence. An upstream detection of at least one essential feature of the waste suspension to be treated, specifically essentially in terms of the treatment intensity, is advantageous in order to estimate the necessary treatment intensity in advance and thus be able to limit the use of resources associated with a treatment to what is required. In particular, it may be provided to align the treatment intensity with an intended treatment duration taking at least one detected indicator as a starting point.

A detection downstream in the process sequence is advantageous in order to be able to verify the success and/or effectiveness of the treatment. It may consequently be provided to subject a waste suspension already treated for the first time to a new treatment if one or more detected actual values deviate from setpoint values. In addition, it may be provided to take into account a corresponding adaptation of the treatment intensity for a further, following, still untreated waste suspension.

Advantageously, an actual value can be detected inline during the treatment and preferably evaluated in real time, for example by the regulation system. Data from an inline detection can be taken as a basis to be able to adapt the treatment intensity, without needing to interrupt a treatment process for this. Indicators detected inline can also contribute to being able to adapt the treatment intensity continuously, and specifically already during the treatment, with the result that both the resource outlay and the loading of the waste materials can be limited to what is necessary.

In the simplest case, it may be provided to regulate the treatment intensity via the duration of a treatment, in such a way that the treatment intensity can be increased as the treatment duration increases. In this context, for example, the period of time during which the waste suspension remains in the treatment chamber of the reactor can be lengthened or shortened. It may also be provided that the waste suspension after a first treatment interval is firstly discharged from a reactor, in order to be fed back to a reactor for further treatment in the further course of the treatment process.

In principle, the present proposal can promote shorter treatment times and thus an increased throughput for the provision of high-quality waste materials, specifically as a result of a treatment intensity aligned with the waste materials to be treated.

For one embodiment of the method, it may be provided to regulate the treatment intensity via adapting the ultrasound, in particular via setting certain frequency ranges. Advantageously, sound emission in the frequency range between 1 kHz and 10 MHz, in particular between 16-60 kHz, particularly preferably 20-60 kHz may be provided.

Conducive to a treatment are elevated process temperatures, these interacting directly with the ultrasound. It is thus advantageously possible to provide temperature control of the waste suspension. The temperature of the treatment liquid is set preferably to 50-90° C., particularly preferably to approximately 60° C. The waste-suspension temperature can be set directly by controlling the temperature of the waste suspension. Indirect temperature control may be provided by controlling the temperature of the treatment liquid, specifically before the waste suspension is produced and/or by addition of supplementary treatment liquid to the waste suspension.

In principle, the interaction between the ultrasound and the waste-suspension temperature can enable a reduced temperature-control outlay, and this can contribute to a saving on energy. With preference, in the case of highly contaminated waste materials, a dry-mechanical cleaning may be provided before the production of the waste suspension in the process sequence, in order in particular to be able to circumvent the otherwise necessary high process temperatures.

Furthermore, the temperature setting may be provided to regulate the treatment intensity. If, for example, one or more detected indicators indicate before the treatment that a high treatment intensity will be necessary, it is possible for example to increase the temperature beforehand, such that it is not always necessary to intensify the ultrasound.

If, for example, during the treatment an excessive drop in temperature in the waste suspension is detected, it may be provided that the emission of the ultrasound is intensified in the short term, in order to be able to ensure overall a certain degree of a required treatment intensity.

For a further embodiment of the method, it may be provided that the waste suspension is conveyed with formation of a waste-suspension stream, wherein a homogeneous volume flow can be advantageous for a sufficient treatment quality.

The conveying may be configured such that the waste suspension flows for example from the mixing vessel to the reactor and/or from a first reactor to a second reactor. Advantageously, circulating operation may be provided for the proposed method, such that the waste suspension is fed back to a reactor, in particular if at least one detected indicator indicates that a further ultrasonic treatment is necessary.

It is particularly possible to use the control of the flow velocity of the waste-suspension stream to regulate the treatment intensity, in particular as a response to a detected indicator. In principle, the treatment intensity can be increased with decreasing flow velocity, comparably to a lengthier treatment duration.

In general, the alignment of the ultrasound propagation can influence the treatment intensity. It may be provided that the propagation direction of the ultrasound is applied substantially opposite to the flow direction of the waste-suspension stream, in order to be able to realize a homogeneous and intensive treatment without for example a higher energy consumption being necessary for this.

In particular for comminuted waste materials with a low moisture content, it may be provided that the waste materials before the treatment are blended with a treatment liquid to produce the waste suspension. Firstly, the conveying of a waste suspension can be simplified in comparison with waste materials with only low moisture contents. Secondly, a high moisture content is a prerequisite for the effectiveness of an ultrasonic treatment. Thirdly, a waste suspension enables a homogeneous distribution in the treatment chamber of the waste materials to be treated and thus a fully comprehensive, efficient treatment. The mixing can be carried out in a reactor and in a mixing vessel provided for this.

For a further embodiment of the proposed method, it may be provided that agents or auxiliaries, for example caustic soda solution, which can contribute to being able to reduce the treatment intensity required for specific waste materials and thus the associated required resource consumption, are added to the waste suspension. In particular to ascertain the amount of substance of certain auxiliaries, it may be provided to detect for example the pH of the waste suspension, which can permit conclusions to be drawn about the conversion of auxiliaries by reaction in the waste suspension. If, for example, during the treatment a detected amount of an auxiliary exceeds a required magnitude, the treatment intensity can be regulated, such that for example the intensity of the ultrasound is increased or additional treatment liquid with a higher temperature is fed in. Within the context of environmental protection, it is important to reduce the addition of auxiliaries which are not converted by the treatment, but rather remain in the treatment liquid and must be removed afterwards with outlay.

Advantageously, after the treatment a separation of the waste materials by type may be provided, for example by means of a sink-float method. Within the framework of a comprehensive processing of the waste materials and to prepare for further processing, it is possible to provide drying of the waste materials.

The proposed invention will be explained in more detail on the basis of purely schematic exemplary embodiments. In the drawing:

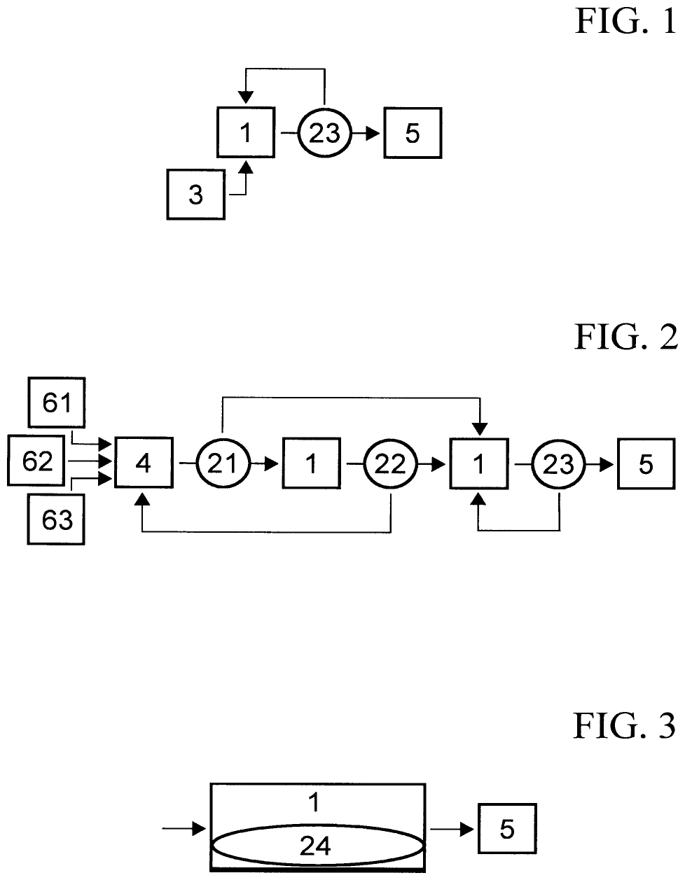

FIG. 1 shows a schematic illustration of a method sequence with detection of an amount of substance after a treatment,

FIG. 2 shows a schematic illustration of a method sequence with detection of an amount of substance after and before a treatment, and

FIG. 3 shows a schematic illustration of a method sequence with detection of an amount of substance during a treatment.

The features of the exemplary embodiments illustrated below may, according to the invention, be provided in principle individually or in combinations.

FIG. 1 shows a schematic illustration of a method sequence, with an amount of substance being detected downstream 23 of the ultrasonic treatment 1.

Firstly, the waste suspension is transferred to the treatment chamber of a reactor. In the process, either the waste suspension to be treated can be fed directly or the comminuted waste materials, the treatment liquid and optionally auxiliaries can be conducted into the treatment space separately, with the result that mixing to produce the waste suspension takes place in the treatment chamber. A stirring mechanism arranged in the treatment chamber of the reactor homogenizes the waste suspension.

After the addition and/or after the production of the waste suspension, it is subjected to an ultrasonic treatment 1. In the process, the treatment parameters, in particular the frequency range of the ultrasound and the treatment duration, are set to define the treatment intensity. After the end of the ultrasonic treatment 1, an amount of substance is detected 23, specifically the amount of suspended matter in the waste suspension. To this end, a defined amount of the liquid phase of the waste suspension is conducted through a filter. The amount of suspended matter in the filter is determined by gravimetry and reflects a detected actual value. Taking the composition of the comminuted waste materials as a starting point, optionally in conjunction with empirical values, the deviation of the actual value from a setpoint value is determined. In other words, it is ascertained whether the processing is sufficient, for example in terms of a degree of cleaning or breaking up. If the deviation is outside a tolerance range that depends on the waste material, the waste suspension is subjected to an ultrasonic treatment 1 again, so that effectively the treatment intensity is regulated within the framework of a lengthened treatment duration. If the deviation is within the tolerance range or no deviation can be established, the waste materials are then density-separated from the waste suspension using the sink-float method. For reasons of better transportability, the waste materials by type are dried in the further course of the process to prepare for subsequent processing.

On a case-by-case basis, in the event of a significant deviation in the actual value, it is optionally possible to additionally set 3 a higher temperature of the waste suspension. In interaction with the ultrasound, the treatment intensity can thus be precisely regulated. If, for example, the treatment duration is to be shortened, the treatment intensity must be increased, for example in such a way that a higher temperature is set 3 and/or the power of the ultrasound is increased.

A schematic illustration of a further method sequence with detection of an amount of substance after and before 22 an ultrasonic treatment 1 is illustrated in FIG. 2. In addition to the method illustrated, for a further exemplary embodiment not illustrated in the present case a similar method may be provided, it being possible for the process illustrated in FIG. 1 to also be part of a more complex method, which at least in terms of process steps contains a method according to FIG. 1 taking a method according to FIG. 2 as a starting point.

The comminuted waste materials, the treatment liquid and, in individual cases, also auxiliaries are metered 61, 62, 63 and mixed 4 in a mixing vessel to produce the waste suspension. In particular the metering of the auxiliaries 63 is carried out generally only in small amounts, since they have a high effectiveness but can be a not inconsiderable burden on the environment, such that it can be complex to purify the treatment liquid, if there is not a complete conversion of the auxiliaries during the treatment. The waste suspension is homogenized in the mixing vessel by means of a stirring mechanism. In the homogenized waste suspension, firstly a first amount of substance is detected 21, specifically for example the amount of suspended matter in the liquid phase of the waste suspension. The amount of suspended matter received in a filter is detected by gravimetry to establish an actual value. The setpoint value defined is a larger amount of substance that depends on the waste material and is set according to experience for example in the event of a sufficient degree of processing. The deviation of the actual value from the setpoint value is used to derive the necessary treatment intensity and to regulate the procedure required for this.

In addition, within the framework of the upstream detection 21, an amount of substance can be determined by spectroscopy, in particular if it can be derived from relative fractions of specific substances whether for example a certain bond strength of a substance composite is to be expected, for example owing to the detection of certain adhesive-substance fractions, that such a corresponding treatment intensity will be necessary to be able to sufficiently break up this substance composite within the framework of the processing.

After the ultrasonic treatment 1, a further, downstream detection 22 of an amount of substance is carried out. In addition to the determination of the suspended matter by gravimetry, the pH of the waste suspension can also be detected. If a sufficient deviation can be established, the waste suspension is conducted back to the mixing vessel and an additional auxiliary is metered 63 and added within the framework of regulating the treatment intensity, for example caustic soda solution. In the further course of the process, the addition can involve a further ultrasonic treatment 1, which is followed by a downstream substance detection 23.

Proceeding from the actual value of this detection of an amount of substance, the waste suspension is either conducted to density separation 5 or, in the event of a sufficient deviation, subjected to a further ultrasonic treatment 1, the treatment intensity being matched to the ascertained amounts of substance, in particular the amount of suspended matter.

If during the downstream detection 22 of an amount of substance a deviation of the actual value is established in an order of magnitude which does not appear to make the addition of further auxiliaries necessary, the treatment intensity for the subsequent ultrasonic treatment 1, in particular the ultrasonic power and/or the treatment duration, is regulated within the framework of an upstream detection 22 of an amount of substance.

Such a method allows an adapted procedure, which is optimally tailored to the waste material to be treated, it being possible to keep the resources used to a minimum. In addition, there is the possibility of being able to selectively regulate individual process parameters by adapting the rest of the parameters in accordance with external boundary conditions. If, for example, a short treatment duration is intended, in particular a then necessary adaptation of the ultrasonic power or of the waste-suspension temperature can be carried out without significantly compromising the qualitative result of the recycling.

FIG. 3 shows a schematic illustration of a method with detection of an amount of substance during 24 an ultrasonic treatment 1, it in particular also being possible for this exemplary embodiment to be provided as a subprocess of a method. For example, incorporation in a method as illustrated in FIG. 1 or 2 may be provided.

The waste suspension situated in the treatment chamber of a reactor is monitored, preferably repeatedly, during the ultrasonic treatment 1 such that amounts of substance in the waste suspension are detected by photometry. To this end, for example the absorption behavior of the aqueous phase of the waste suspension can be used to detect the amount of suspended matter. A real-time evaluation makes it possible for an automated regulation system to prompt an adaptation of the treatment intensity directly even during the ultrasonic treatment 1, if a detected actual value significantly deviates from a setpoint value, specifically in particular by controlling the power of the ultrasound or modifying the treatment duration. Consequently, the procedure is optimized directly in accordance with the requirements, but the use of resources is kept to a minimum.

### LIST OF REFERENCE SIGNS

1 Ultrasonic treatment
21 Upstream detection of amount of substance
22 Downstream and upstream detection of amount of substance
23 Downstream detection of amount of substance
24 Simultaneous detection of amount of substance
3 Temperature setting
4 Mixing to produce the waste suspension
5 Density separation of the waste materials
61 Metering of the comminuted waste materials
62 Metering of the treatment liquid
63 Metering of auxiliaries

1. A plant for treating comminuted waste materials, comprising a reactor having a treatment chamber for receiving a waste suspension, which contains the waste materials and a treatment liquid,
comprising at least one ultrasonic generator,
and comprising a control unit, with which the ultrasonic generator can be set and which serves to set a treatment intensity,
characterized by
a detection unit, which serves to determine an amount of substance in the waste suspension.

2. The plant as claimed in claim 1,
wherein the detection unit has a filter apparatus, which filters suspended matter out of the waste suspension.

3. The plant as claimed in claim 1,
wherein the detection unit has an optical and/or a spectroscopic functionality for detecting the suspended matter in the waste suspension.

4. The plant as claimed in claim 1,
wherein the plant has a regulation system, which connects the control unit and the detection unit to one another with signal transmission.

5. The plant as claimed in claim 4,
wherein the plant has a temperature-control unit, which serves to set the temperature of the waste suspension, and which is incorporated with signal transmission in the regulation system.

6. The plant as claimed in claim 1,
wherein the plant has a mixing vessel with a stirring mechanism, wherein the mixing vessel is connected with throughflow action to the reactor.

7. The plant as claimed in claim 6,
wherein the plant has a metering device with at least one metering element, which is connected with throughflow action to the reactor and/or the mixing vessel.

8. The plant as claimed in claim 1,
wherein at least two reactors that are connected to one another with throughflow action are arranged.

9. The plant as claimed in claim 4,
wherein the plant has a conveying apparatus,
which brings about a waste-suspension stream,
and which is incorporated with signal transmission in the regulation system.

10. The plant as claimed in claim 9,
wherein the reactor has an impact wall, which is arranged in the waste-suspension stream and to which at least one ultrasonic generator is assigned with sound transmission.

11. The plant as claimed in claim 1,
wherein the reactor is substantially tubular and is configured for the waste suspension to flow through it.

12. A method for treating comminuted waste materials,
wherein the waste materials are present in a treatment liquid in the form of a waste suspension,
and wherein the waste suspension is subjected to an ultrasonic treatment (1),
characterized
in that, in the waste suspension, at least one amount of substance is detected as actual value,
and in that a treatment intensity is regulated in the event of a deviation of the actual value from a setpoint value.

13. The treatment method as claimed in claim 12,
wherein a detection before (21) and/or after (23) the ultrasonic treatment (1) of the waste suspension takes place.

14. The treatment method as claimed in claim 12,
wherein a detection during (24) the ultrasonic treatment (1) of the waste suspension takes place.

15. The treatment method as claimed in claim 12,
wherein the treatment intensity is regulated via the treatment duration.

16. The treatment method as claimed in claim 12,
wherein the treatment intensity is regulated via the frequency range of the ultrasound.

17. The treatment method as claimed claim 12,
wherein the temperature of the waste suspension is set (3),
and wherein the treatment intensity is regulated via the temperature of the waste suspension.

18. The treatment method as claimed in claim 12,
wherein the waste suspension is conveyed with formation of a waste-suspension stream and the flow velocity of the waste-suspension stream is controlled to regulate the treatment intensity.

19. The treatment method as claimed in claim 18,
wherein the propagation of the ultrasound is aligned substantially opposite to the flow direction of the waste-suspension stream.

20. The treatment method as claimed in claim 12,
wherein the waste materials are mixed (4) with a treatment liquid to produce a waste suspension.

21. The treatment method as claimed in claim 12,
wherein auxiliaries are added to the waste suspension.

22. The treatment method as claimed in claim 21,
wherein caustic soda solution is added.

23. The treatment method as claimed in claim 12,
wherein the treated waste materials are separated from one another by type.

24. The treatment method as claimed in claim 12,
wherein the treatment liquid is discharged from the waste suspension and the treated waste materials are dried.
